(19) United States
(12) Patent Application Publication
(10) Pub. No.: US 2016/0236822 A1
(43) Pub. Date: Aug. 18, 2016

(54) PULP MOLDED CONTAINER WITH DOUBLE-SIDED COATING

(71) Applicant: HSIN-HUNG CHOU, TAIPEI CITY (TW)

(72) Inventor: HSIN-HUNG CHOU, TAIPEI CITY (TW)

(21) Appl. No.: 14/620,358

(22) Filed: Feb. 12, 2015

(51) Int. Cl. B65D 25/14; B65D 71/08; B65D 25/02; B32B 1/02; B32B 29/00

(52) U.S. Cl. CPC B65D 25/14; B32B 1/02; B32B 29/005; B65D 25/02; B65D 71/08; B32B 2439/02; B32B 2439/70; B32B 2255/12; B32B 2255/26

(57) ABSTRACT

A pulp molded container with double-sided coating comprises an inner container formed by a pulp molded inner body, an inner film molded and coated on the top surface of the inner body to form a coated inner pulp molded container, an outer container formed by a pulp molded outer body, and an outer film molded and coated on the undersurface of the outer body to form a coated outer pulp molded container. Then overlaying and binding the inner pulp molded container on the outer pulp molded container to form a pulp molded container with double-sided coating that has the softening problem improved since the liquid inside would not permeate and the container would not soften due to dampness; also, because of the perfectly sealed structure, it would not have scraps of paper attached when being piled up.

### BACKGROUND OF THE INVENTION

1. Field of the Invention

The present invention relates to a pulp molded container with double-sided coating, particularly to one that has a perfectly sealed structure formed by binding an inner and an outer pulp molded containers and then coating films on both inside and outside thereof.

2. Description of the Related Art

Conventional disposable trays are usually made of plastics, polystyrene, or paper pulp, among which the one made of polystyrene would release toxic substances that are harmful to human body when being exposed to heat: plus, it cannot be decomposed by the nature environment. Therefore, it is forbidden to use polystyrene as the materials for disposable trays.

On the other hand, most of the disposable trays made of paper pulp contain a mixture with paper pulp and other materials. Such products would have the inner surface softened due to permeating sauces or juices of the food and the outer surface damped for the same reason; in other words, they are not waterproof. To overcome the defect, a waterproof film 102 is molded on the inner surface of a paper pulp container 101 as shown in FIG. 1, forming a paper pulp molded container with single side coated 100 that separates the liquids from the contents and solves the problem. However, current process in paper pulp molding is to dry and set the shape of the paper pulp container 101, then place the film 102 and mold it on the inner surface by vacuuming from the outer surface 103. The outer surface 103 cannot be vacuum molded since the inner surface is already been through the process. Therefore, the paper pulp molded containers 101 in the market only have single side coated which may get softened due to dampness. Still, they are usually placed in piles for transportation and storage, resulting in the inner surface of one contacting the outer surface of another one and thus having scraps of paper attaching therein; and this may contaminate the contents, especially food. Besides, there are other defects of weak structures for supporting the contents and inability to insulate the heat. In short, there is still room for improvements.

### SUMMARY OF THE INVENTION

It is a primary object of the present invention to provide a pulp molded container with double-sided coating that the outside thereof would not be damped and the inside thereof would not have scraps of paper attached.

Another object of the present invention is to provide a pulp molded container with double-sided coating that has an enhanced and heat insulating structure.

Yet another object of the present invention is to provide a pulp molded container with double-sided coating that can separate the juices from the fresh contents like fishes and poultry to keep the freshness of the contents.

In order to achieve the objects mentioned above, the present invention comprises an inner container formed by a pulp molded inner body having a first surface on the inner surface thereof, a second surface on the outer peripheral wall thereof, and a first binding rim extended from the peripheral edge of the opening thereof, having a top surface and a undersurface; an inner film coating and binding with the first surface of the inner body and the upper surface of the first binding rim, so as to form an inner pulp molded container with film coated on the inner surface; an outer container formed by a pulp molded outer body with the opposite shape to the inner container, having a third surface on the inner surface thereof, a fourth surface on the outer peripheral wall thereof, and a second binding rim extended from the peripheral edge of the opening thereof correspondingly to the first binding rim, having a top surface and a undersurface; an outer film coating and binding with the fourth surface of the outer body and the undersurface of the second binding rim, so as to form an outer pulp molded container with film coated on the outer surface that has the opening thereof having the same direction with the one of the inner pulp molded container; and a space left between the second surface of the inner body and the third surface of the outer body when the inner pulp molded container is overlaid on the outer pulp molded container and the undersurface of the first binding rim is bound with the top surface of the second binding rim for binding the inner and outer pulp molded containers to form a pulp molded container with double-sided coating.

Moreover, the first and second binding rims thereof further have a piece of film left around the edge to be heat-sealed and form a sealed edge. The second surface of the inner body has a plurality of horizontal protrusions spaced thereon, and the third surface of the outer body has a plurality of vertical protrusions arranged thereon, so as to form an enhancing crisscross structure after binding; or the second surface of the inner body has a plurality of vertical protrusions arranged thereon, and the third surface of the outer body has a plurality of horizontal protrusions spaced thereon, so as to form an enhancing crisscross structure after binding. And the present invention further has a plurality of diversion holes arranged on the bottom surface of the inner pulp molded container to link to the space left between the second and the third surfaces.

With structures disclosed above, the present invention overcomes the problem of the conventional pulp molded trays with only single side coated, preventing the liquid from permeating through or softening the inside thereof with dampness. In addition, the perfectly sealed structure prevents from scraps of paper attaching when piling up the present invention, and the double binding structure and the crisscross protrusions in the space in-between further enhances the structure and the heat insulating function.

### BRIEF DESCRIPTION OF THE DRAWINGS

FIG. 1 is a sectional view of a pulp molded tray with single side coated structure according to the prior art;

FIG. 2 is an exploded view of the present invention in a preferred embodiment;

FIG. 2A is a schematic diagram of the forming of the outer pulp molded container thereof;

FIG. 3 is an exploded view of the main structure thereof;

FIG. 4A is a perspective view of the present invention in an applicable embodiment;

FIG. 4B is a perspective of the present invention in another applicable embodiment;

FIG. 5 is an exploded view of the structure of the present invention; and

FIG. 6 is a partially enlarged view of FIG. 5.

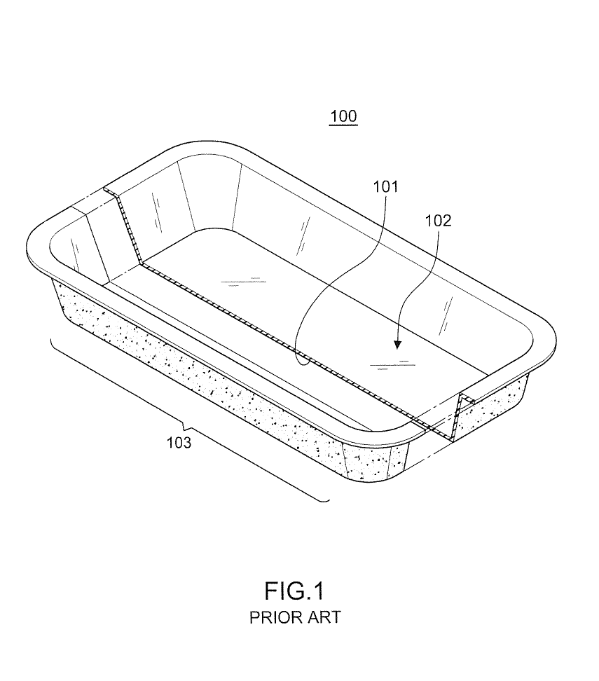

### DETAILED DESCRIPTION OF THE PREFERRED EMBODIMENT

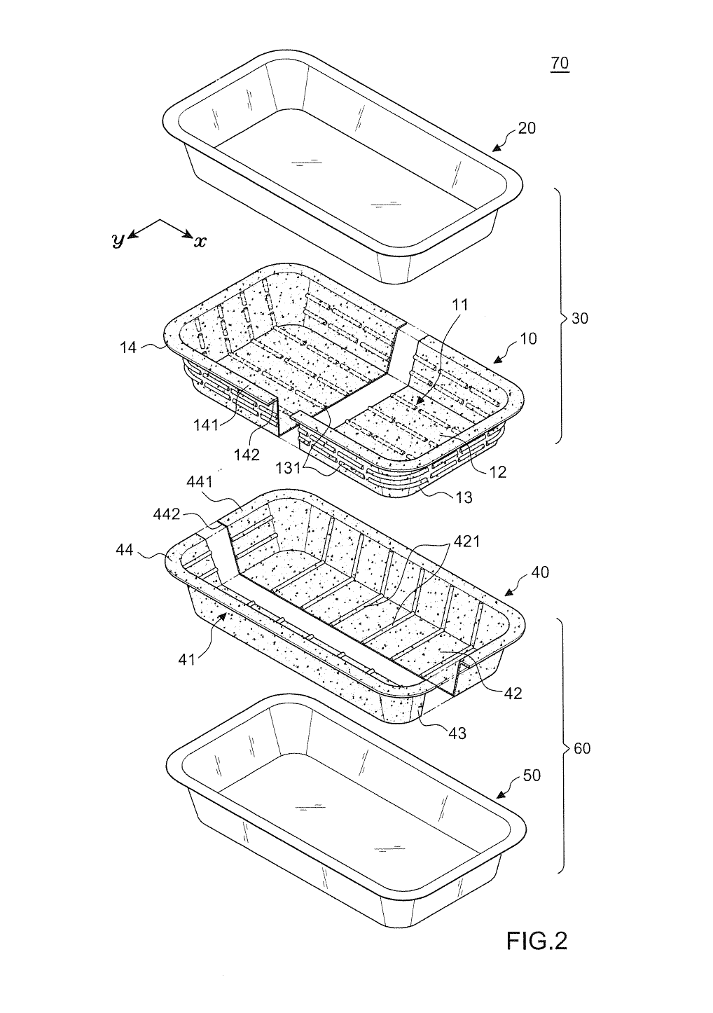

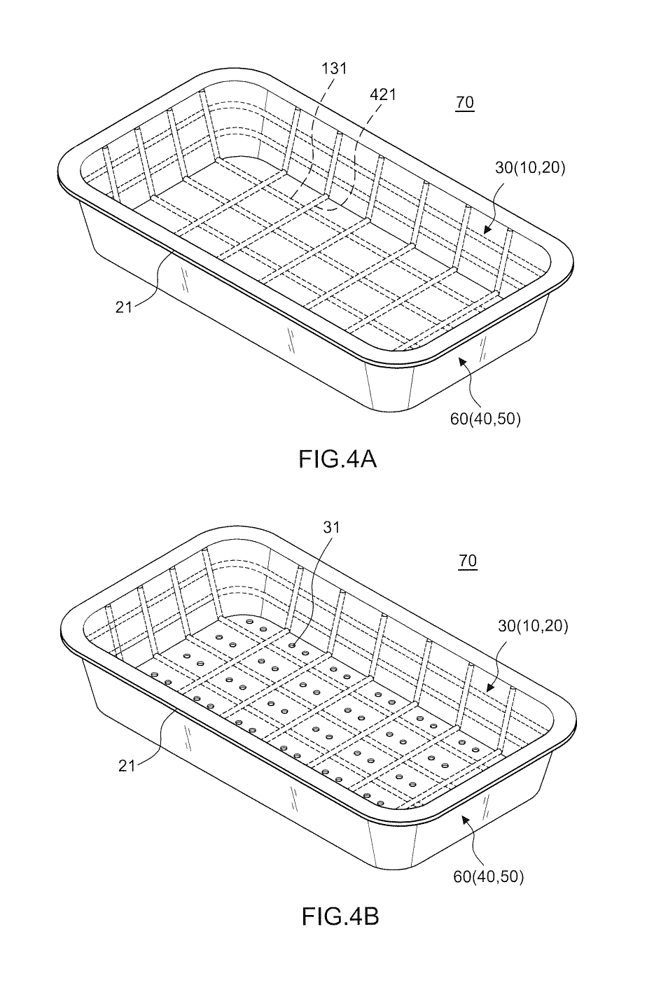

Referring to FIGS. 2-6, in a preferred embodiment, the present invention comprises an inner container 10 and an inner film 20. The inner container 10 is formed by a pulp inner body 11 molded in an inner mold having a first surface 12 on the inner surface thereof, a second surface 13 on the outer peripheral wall thereof, and a first binding rim 14 extended from the peripheral edge of the opening thereof, having a top surface 141 and a undersurface 142. The inner film 20 is coating and binding with the first surface 12 of the inner body 11 and the upper surface 141 of the first binding rim 14, so as to form an inner pulp molded container 30 with film coated on the inner surface. Such structure can be found in the prior art and is illustrated in the upper half of FIG. 2.

However, the structure disclosed above only has single side coated instead of both sides. The present invention further comprises an outer container 40 and an outer film 50. The outer container 40 is formed by a pulp outer body 41 molded in an outer mold that has the opposite shape to the inner container 10. Referring to FIG. 2, the outer body 41 has a third surface 42 on the inner surface thereof, a fourth surface 43 on the outer peripheral wall thereof, and a second binding rim 44 extended from the peripheral edge of the opening thereof correspondingly to the first binding rim 14, having a top surface 441 and a undersurface 442; the fourth surface 43 on the outer peripheral wall is on the outer mold and the third surface 42 is facing down in the molding process for the fourth surface 43 to be coated in the next manufacturing process and for fitting the shape of the inner container 10 as well.

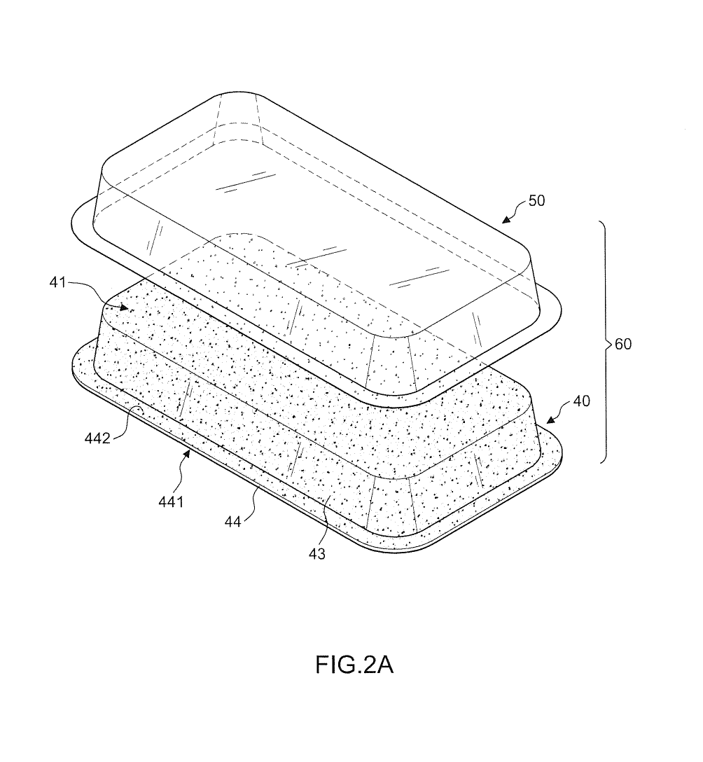

The outer film 50 is coating and binding with the fourth surface 43 of the outer body 41 and the undersurface 442 of the second binding rim 44, so as to form an outer pulp molded container 60 with film coated on the outer surface that has the opening thereof having the same direction with the one of the inner pulp molded container 30 as shown in FIG. 3 for the next binding process.

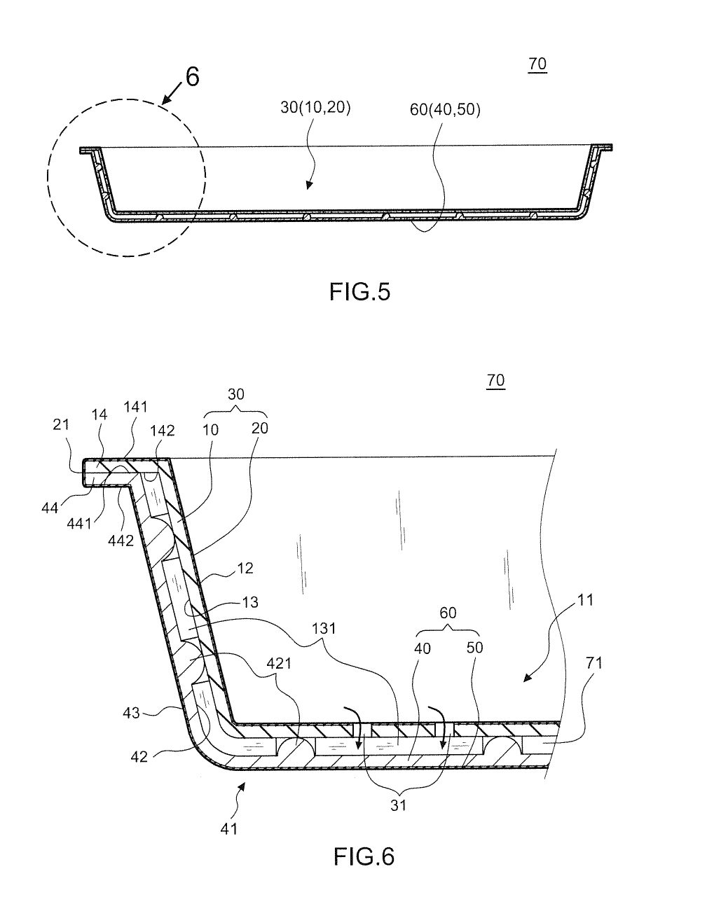

Then, when the inner and outer pulp molded containers 30, 60 are individually manufactured, the first and second binding rims 14, 44 thereof could have a piece of film—from either the inner film 20 or the outer film 50 or from both—for about 2 mm left around the edge; overlaying the inner pulp molded container 30 onto the outer pulp molded containers 60 and leaving a space 71 left between the second surface 13 of the inner body 11 and the third surface 43 of the outer body 41 as shown in FIG. 6, then heat-sealing and binding the undersurface 142 of the first binding rim 14 with the top surface 441 of the second binding rim 44 to form a sealed edge 21, so as to form a pulp molded container with double-sided coating 70. The present invention is therefore waterproof. Besides, with the structure of the space 71 between the inner and outer pulp molded containers 30, 60, the present invention is heat insulating as well when being filled with steaming food.

In the embodiment, the present invention is designed in a shape of a tray but it is not limited to such application. It can also be a bowl, a packaging box, or a lunch box. On the other hand, the inner film 20 and the outer film 50 can be made of Polyethylene (PE), Polyethylene Terephthalate Glycol (PETG), or Polylactic Acid (PLA), but they still have other applicable materials as well.

Furthermore, in this embodiment, the second surface 13 of the inner body 11 has a plurality of horizontal protrusions 131 (as in the direction of the X axis in FIG. 2) spaced thereon, and the third surface 42 of the outer body 41 has a plurality of vertical protrusions 421 in the direction of the Y axis in FIG. 2) arranged thereon, so as to form an enhancing crisscross structure after binding; it is also applicable to have the second surface 13 of the inner body 11 having a plurality of vertical protrusions 421 arranged thereon, and the third surface 42 of the outer body 41 has a plurality of horizontal protrusions 131 spaced thereon.

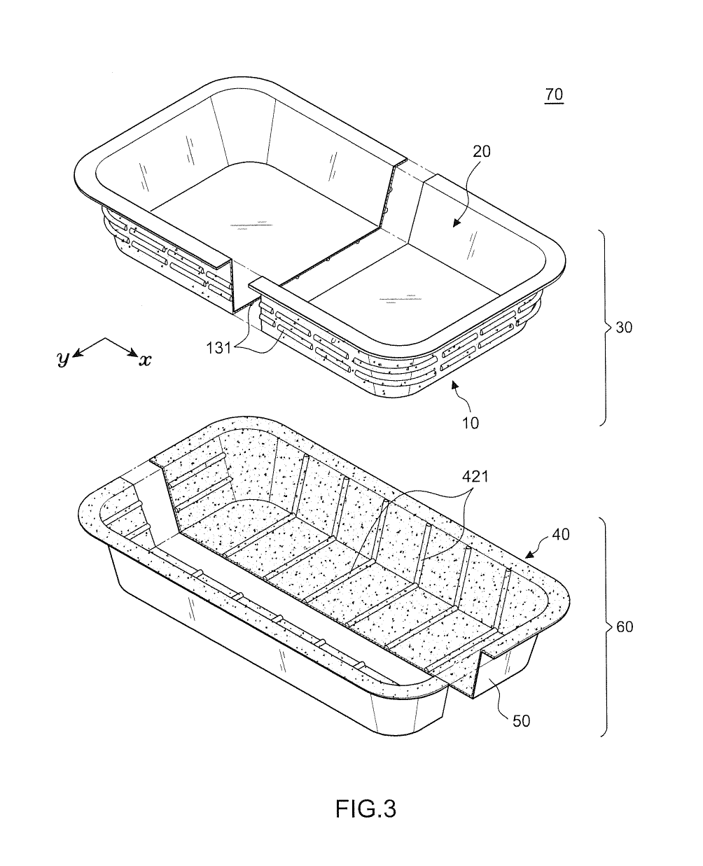

FIG. 4A is another applicable embodiment of the present invention. In this embodiment, it has the same structures disclosed above but further includes a plurality of diversion holes 31 arranged on the bottom surface of the inner pulp molded container 30 to link to the space 71 left between the second and the third surfaces 13, 42 as shown in FIGS. 4A and 6. With such structure, the juices or liquids with fresh contents such as fishes, poultry, and steaming food would naturally flow into the diversion holes 31 and further to the space 71 where the uncoated second and third surfaces 13, 42 would absorb it directly without having a sponge or other absorbing materials disposed therein, separating the juices and liquids from the fresh contents and further achieving the purpose of keeping the freshness from getting rotten.

With the structures disclosed above, the present invention overcomes the problem of the conventional pulp molded trays with only single side coated, preventing the juices and liquids from permeating through, softening the inside thereof with dampness, or causing the contents rotten. In addition, the perfectly sealed structure prevents from scraps of paper attaching when piling up the present invention, and the double binding structure and the crisscross protrusions in the space in-between further enhances the structure and the heat insulating function.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A pulp molded container with double-sided coating, comprising
a inner container formed by a pulp molded inner body having a first surface on the inner surface thereof, a second surface on the outer peripheral wall thereof, and a first binding rim extended from the peripheral edge of the opening thereof, having a top surface and a undersurface;
an inner film coating and binding with the first surface of the inner body and the upper surface of the first binding rim, so as to form an inner pulp molded container with film coated on the inner surface;
an outer container formed by a pulp molded outer body with the opposite shape to the inner container, having a third surface on the inner surface thereof, a fourth surface on the outer peripheral wall thereof, and a second binding rim extended from the peripheral edge of the opening thereof correspondingly to the first binding rim, having a top surface and a undersurface;
an outer film coating and binding with the fourth surface of the outer body and the undersurface of the second binding rim, so as to form an outer pulp molded container with film coated on the outer surface that has the opening thereof having the same direction with the one of the inner pulp molded container; and
a space left between the second surface of the inner body and the third surface of the outer body when the inner pulp molded container is overlaid on the outer pulp molded container and the undersurface of the first binding rim is bound with the top surface of the second binding rim for binding the inner and outer pulp molded containers to form a pulp molded container with double-sided coating.

2. The pulp molded container with double-sided coating as claimed in claim 1, wherein the first and second binding rims have a piece of film left around the edge to be heat-sealed and form a sealed edge.

3. The pulp molded container with double-sided coating as claimed in claim 1, wherein the second surface of the inner body has a plurality of horizontal protrusions spaced thereon, and the third surface of the outer body has a plurality of vertical protrusions arranged thereon, so as to form an enhancing crisscross structure after binding.

4. The pulp molded container with double-sided coating as claimed in claim 1, wherein the second surface of the inner body has a plurality of vertical protrusions arranged thereon, and the third surface of the outer body has a plurality of horizontal protrusions spaced thereon, so as to form an enhancing crisscross structure after binding.

5. The pulp molded container with double-sided coating as claimed in claim 1, wherein the present invention further has a plurality of diversion holes arranged on the bottom surface of the inner pulp molded container to link to the space left between the second and the third surfaces.

6. A pulp molded container with double-sided coating as claimed in claim 1, wherein the inner film and the outer film are made of Polyethylene (PE), Polyethylene Terephthalate Glycol (PETG), or Polylactic Acid (PLA).
